(19) United States
(12) Patent Application Publication
(10) Pub. No.: US 2011/0137621 A1
(43) Pub. Date: Jun. 9, 2011

(54) Non-Iterative Mapping of Fan Noise Across a Hydraulic Plane

(75) Inventors: Maurice F. Holahan, Lake City, MN (US); Michael D. O'Connell, Rochester, MN (US)

(73) Assignee: INTERNATIONAL BUSINESS MACHINES CORPORATION, Armonk, NY (US)

(21) Appl. No.: 12/631,110

(22) Filed: Dec. 4, 2009

(51) Int. Cl. G06F 17/10; G06G 7/48

(52) U.S. Cl. 703/2; 703/7

(57) ABSTRACT

In embodiments of the present invention a method and computer program product is presented to map noise levels onto a fan's hydraulic operating plane. In another embodiment this methodology allows for the comparison of a first fan configuration to a second fan configuration to enable the selection of a particular fan configuration to be utilized in an electronic system.

### RELATED FILINGS

The present application is related to pending application Ser. No. 11/830,916, attorney docket number ROC920070266US1, entitled “Mapping Fan Noise Across an Hydraulic Plane,” filed Jul. 31, 2007.

### BACKGROUND OF THE INVENTION

1. Field of the Invention

Embodiments of present invention generally relate to fans or other cooling devices used to remove heat from a server, computer system, or other electronic device. More particularly, embodiments of the present invention relate to a methodology of mapping fan noise across a fan's hydraulic plane in order to compare fan configurations, thus enabling the selection of a particular fan configuration to be utilized in the server, computer system, or other electronic device.

2. Description of the Related Art

The acoustic output of fans has become a thermal constraint in cooling of servers and other electronic systems. The use of larger or faster moving fans is limited because these fans may operate above a desired noise level. Despite this acoustic constraint, thermal designers often fail to fully understand the acoustic consequences of changing the hydraulic operating point of the cooling system design.

### SUMMARY OF THE INVENTION

In an embodiment of the invention, a method for selecting a fan configuration from a plurality of possible fan configurations to be utilized in an electronic system is described. In various embodiments, a fan configuration is a single fan, multiple fans in parallel, multiple fans in series, or multiple fans in parallel and series, or other equivalent configuration. The methodology allows for the comparison of a first fan configuration to a second fan configuration to enable the selection of a particular fan configuration to be utilized in the electronic system.

In various embodiments, a characteristic flow/noise signature is determined for each of the plurality of fan configurations. A target noise isobel level is determined. Target hydraulic operating parameters are determined. The speed necessary for each fan configuration to operate at the target noise isobel level is calculated. The hydraulic operating parameters of each fan configuration when operated at the calculated speed are calculated. And the particular fan configuration to be utilized in the electronic system is selected.

In another embodiment, determining a characteristic flow signature and a characteristic noise signature for each of the plurality of possible fan configurations further comprises, measuring at least the volumetric flow rate, static pressure, impeller rotation speed, and isobel noise level for each of the plurality of possible fan configurations.

In another embodiment, calculating the speed necessary for each fan configuration to operate at the target noise isobel level, further includes calculating the difference between the measured isobel noise level and the target isobel noise level, determining a speed ratio, and multiplying the measured impeller rotation speed by the speed ratio to determine the speed necessary for each fan configuration to operate at the target noise isobel level.

In another embodiment, the speed ratio (N_{R}) is determined by the following expression: N_{R}=10 ^{ΔL/5} where ΔL=Lₘₑₐₛ−L_{isobel}_{_{—}}_{tgt}, where Lₘₑₐₛ is the measured isobel noise level, and where L_{isobel}_{_{—}}_{tgt} is the target isobel noise level.

In another embodiment, calculating the hydraulic operating parameters of each fan configuration when operated at the calculated speed further includes calculating a volumetric flow rate at the target isobel point and calculating a static pressure at the target isobel point.

In another embodiment, the volumetric flow rate at the target isobel point (Qᵢₛₒ_{_{—}}_{tgt}) is determined by the following expression: Qᵢₛₒ_{_{—}}_{tgt}=N_{R}·Q_{measured}, where Q_{measured} is the measured volumetric flow rate.

In another embodiment, the static pressure at the target isobel point (Pᵢₛₒ_{_{—}}_{tgt}) is determined by the following expression: Pᵢₛₒ_{_{—}}_{tgt}=N_{R}²·P_{measured}, where P_{measured} is the measured static pressure.

In another embodiment, selecting the particular fan configuration to be utilized in the electronic system having calculated hydraulic operating parameters similar to the target hydraulic operating parameters further includes determining which fan configuration results in the lowest noise at the hydraulic operating target and/or determining which fan configuration results in the greatest volumetric flow rate and pressure delivery at the target isobel noise level.

By employing these mapping procedures over a sufficient range of fan types, sizes, and combinations, it is possible to assemble an overall picture of the minimum noise levels required to reach specific hydraulic operating targets. Such a map reveals the minimum acoustic consequences of achieving hydraulic design points. The volumetric consumption of each fan option is over-plotted to show the acoustic benefit of allowing more space in a system design.

This and other features, aspects, and advantages will become better understood with reference to the following description, appended claims, and accompanying drawings.

### BRIEF DESCRIPTION OF THE DRAWINGS

So that the manner in which the above recited features of the present invention are attained and can be understood in detail, a more particular description of the invention, briefly summarized above, is had by reference to the embodiments thereof which are illustrated in the appended drawings.

It is to be noted, however, that the appended drawings illustrate only typical embodiments of this invention and are, therefore, not to be considered limiting of its scope, for the invention may admit to other equally effective embodiments.

FIG. 1 illustrates flow and noise data for a 120×38 mm high performance mixed flow tube axial fan taken at 3 motor voltages, according to an embodiment of the present invention.

FIG. 2 illustrates a noise surface in three dimensions: X: volumetric flow rate (CFM), Y: static pressure (pa), Z: sound power level L_{WA} (bels), according to an embodiment of the present invention.

FIG. 3 illustrates level lines of sound power; isobels forming a noise surface, according to an embodiment of the present invention.

FIG. 4 illustrates a methodology to determine fan operating parameters resulting in a constant noise output in the hydraulic plane of fan performance, according to an embodiment of the present invention.

FIG. 5 illustrates unit level fan data that is measured to baseline, and where the fan has a constant motor voltage input, according to an embodiment of the present invention.

FIG. 6 illustrates an example where the target isobel noise level is 6.1 BELS Lwa, and the fan operating parameters in the hydraulic plane to achieve the target Isobel noise level, according to embodiments of the present invention.

FIG. 7 illustrates an example where the target isobel noise level is 7.1 BELS Lwa, and the fan operating parameters in the hydraulic plane to achieve the target Isobel noise level, according to embodiments of the present invention.

FIG. 8 illustrates isobels at 6.4 bels L_{WA}, for diameters at 75% and 125% of original diameter, according to an embodiment of the present invention.

FIG. 9 illustrates isobels at 6.4 bels L_{WA}, for various fan systems: a single fan, and series/parallel combinations of multiple fans, according to an embodiment of the present invention.

FIG. 10 illustrates noise difference contours LWA₁−LWA₂ for a 150 mm fan 1 compared to a 120 mm fan 2, according to an embodiment of the present invention.

FIGS. 11A and 11B illustrate a noise difference surface LWA₁−LWA₂, divided into two regions: FIG. 11A where 120 mm fan 2 is quieter, and FIG. 11B where a 150 mm fan 1 frame is quieter, according to embodiments of the present invention.

FIG. 12 illustrates a method for selecting a fan configuration from a plurality of possible fan configurations to be utilized in an electronic system, according to an embodiment of the present invention.

### DETAILED DESCRIPTION

Embodiments of the present invention provide a methodology to compare various fan configurations to enable the selection of a particular fan configuration to be utilized in the server, computer system, or other electronic device.

For a better understanding of the present invention, together with other and further features and advantages thereof, reference is made to the following description, taken in conjunction with the accompanying drawings, and the scope of the invention will be pointed out in the appended claims.

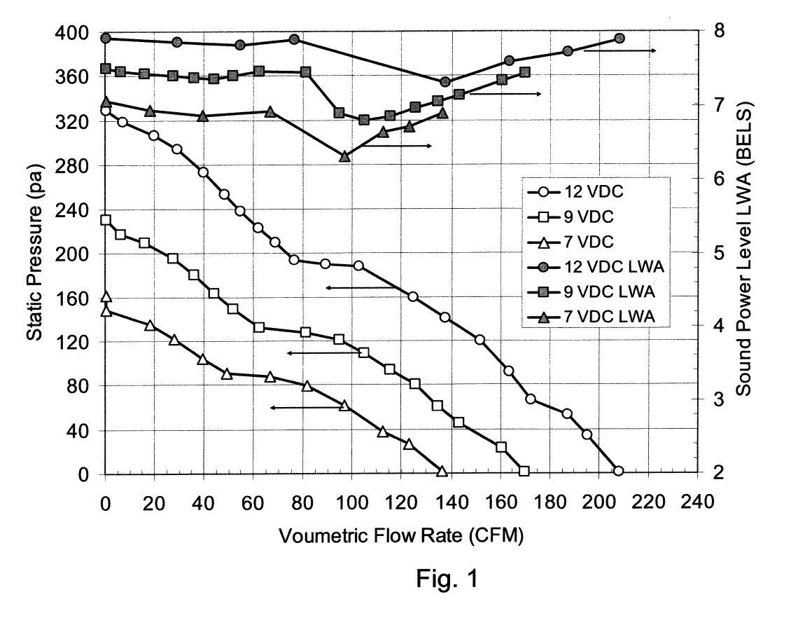

It will be understood that the components of the present invention, as generally described and illustrated in the Figs. herein, are arranged and designed in a wide variety of different configurations. Thus, the following more detailed description of the embodiments of the system, computer program product, and method of the present invention, as represented in FIGS. 1 through 12, is not intended to limit the scope of the invention, as claimed, but is merely representative of selected embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Embodiments of the present invention are described below with reference to flowchart illustrations and/or block diagrams of methods, systems, and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions are provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. Any combination of one or more computer usable or computer readable medium(s) is utilized. The computer-usable or computer-readable medium is, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, a magnetic or other such storage device, or a design process system utilized in the design, manufacturing, and or testing of an electronic component or system.

In some alternative implementations, the functions noted in the block may occur out of the order noted in the figures. For example, two blocks shown in succession may, in fact, be executed concurrently, or the blocks may sometimes be executed in the reverse order, depending upon the functionality involved.

One of the functions of a fan, air mover, or air exchanger, is to produce air flow and pressure. It is usually beneficial to maximize air flow and pressure in a server or other air-cooled electronic system in order to cool the server or electronic system effectively. However, if the air flow and pressure is maximized, the fan(s) creating the air flow and pressure may operate above a noise threshold.

In cooling applications where fans are used to provide fluid volumetric flow at pressure, the optimum geometry, maximum volumetric efficiency, and resulting net thermal conductance that can be attained from a high performance compact heat exchanger (e.g. heat sink, etc.) depends on the specific heat and conductivity of the gas moving within its passages, and on the thermal conductivity of the material forming the passages. More importantly, heat exchanger performance is itself bounded by the volumetric flow and pressure that can be delivered to it by a fan, in the following ways: At one extreme, the free-air volumetric flow delivery of an air mover defines the maximum thermodynamic conductance that would be achievable with an infinitely large heat exchanger. At the other extreme, the shutoff pressure of the air mover bounds the maximum volumetric conductance that can be achieved. Within these limits, the actual operating point of the air mover determines the potential cooling capacity; it fixes the number of channels that can be supported at a particular pressure drop. The availability of flow and pressure is thus integral to defining the optimum forced-air heat transfer geometry.

The hydraulic operating plane is a parameter space where heat exchanger design optimization, fan delivery, and acoustic output converge. The hydraulic plane is formed by intersecting the volumetric flow rate axis with the static pressure axis. Normally volumetric flow rate is plotted on the abcissa, and static pressure is plotted on the ordinate. The hydraulic plane is typically used in conjunction with the following elements: A fan operating characteristic curve is a plot on the hydraulic plane showing the net flow rate delivered by the fan under a range of static pressures. A system load curve is a plot on the hydraulic plane showing the resistive flow impedance of the system at a series of flow rates. The intersection of the system load curve with the fan operating characteristic curve reveals the operating point for the fan-system combination.

FIG. 1 depicts a set of pressure, volumetric flow rate, and noise measurements according to a present embodiment of the invention. These measurements are taken according to ISO10302, Acoustics—Method for the measurement of airborne noise emitted by small air-moving devices, herein incorporated by reference. The flow and noise measurements are collected with a plenum as described in ISO 10302. The example depicted in FIG. 1 is for a 120×38 mm mixed flow fan at three motor speed (e.g. voltage, etc.) settings. The pressure, volumetric flow rate, and noise measurements are arranged in graphical form to create noise signature curves where pressure may be on the left ordinate, sound power on the right ordinate, paired against volumetric flow rate on a common abscissa.

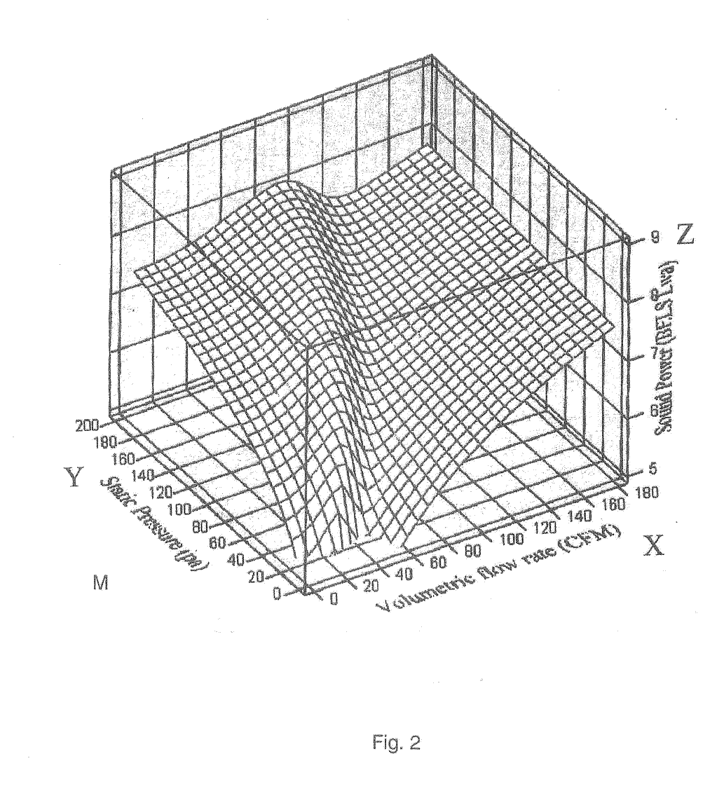

The pressure, volumetric flow rate, and noise measurements may also be arranged in a three-dimensional noise surface as shown in FIG. 2. This type of three-dimensional noise surface is useful to understand qualitative trends, but is difficult to make quantitative comparisons. The general qualitative relationship between static pressure, volumetric flow rate, and sound power level is as follows: As the static pressure and the volumetric flow rate of the air moving device decreases, so does the sound power level of the air moving device.

The existence of the sound power level as function of volumetric flow rate and static pressure is more thoroughly explored by means of a two-dimensional noise contour plot. Lines of a constant noise level, termed isobels, are drawn by connecting all points where the sound power reaches a similar noise level in the hydraulic plane. The gradient of the noise level is perpendicular to the tangent of the contour line, and the relative spacing between uniformly incremented lines is indicative of the magnitude of the gradient. A 2-D noise contour map provides most of the visual cues of the 3-D noise surface, with the advantage that numerical values are read directly from the plot.

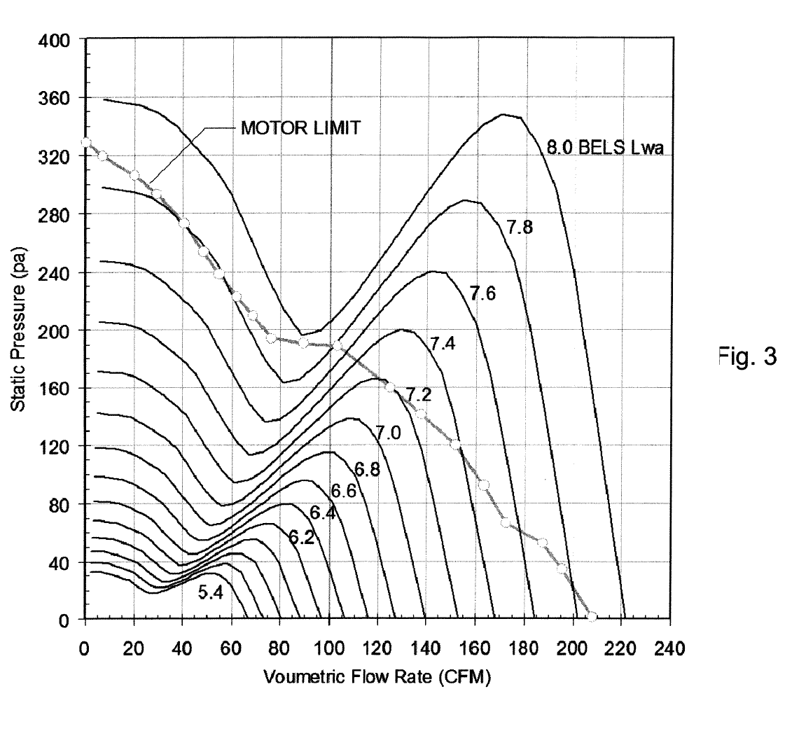

FIG. 3 shows an example of this type of 2-D noise contour plot of sound level lines overlaid on the hydraulic plane with isobels spaced at 0.2 decibel intervals. Full contours are mapped up to a level of 8.0 bels; however, the speed of this particular device is limited to the flow curve indicated by “MOTOR LIMIT”. Projections above this curve show noise levels that would be attained with a more powerful motor.

### Model Development

In an embodiment of the present invention, a methodology is developed to calculate the volumetric flow rate and static pressure of an air moving device at a defined isobel. The method facilitates direct comparison of sound power levels for different fan configurations (i.e., speeds, diameters, device types, and multiple fans in parallel and series combinations, etc.) on a common hydraulic plane. The direct comparison, for example, enables the selection of a particular fan configuration outputting the maximum pressure and flow within a noise level threshold. This selected configuration may then be utilized in the server, computer system, or other electronic device.

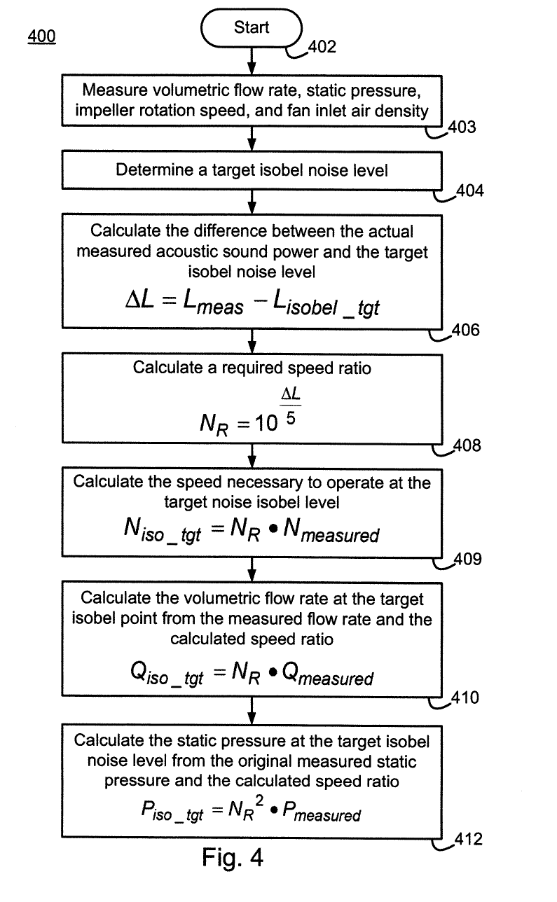

FIG. 4 depicts a methodology 400 to determine fan volumetric flow rate and static pressure that result in a constant noise output across the entire hydraulic plane, according to an embodiment of the present invention. Methodology 400 starts at block 402.

A data collection process occurs to obtain a characteristic flow and noise signature of the device which encompasses points of rating from shut-off to free air (block 404). The data for each point of rating may include volumetric flow rate, static pressure, impeller rotation speed, and fan inlet air density. Volumetric flow rate and static pressure may be measured on a flow test bench according to ANSI/ACME Standard 210-99, Laboratory Methods of Testing Fans for Aerodynamic Performance Rating to determine the volumetric flow rate and static pressure. The pressure range covers shutoff to free air with uniformly distributed points sufficient in number to resolve the knee of the curves. A set of twenty points is adequate. The data is taken at a single fixed motor voltage or speed control setting.

The sound power of the air moving device is then be determined. The air moving device may, for example, be mounted on a noise test plenum to measure sound power following ISO 10302 to determine the noise signature. The plenum is an acoustically transparent enclosure having an adjustable exhaust aperture to control the static pressure load. The measured data includes inlet air density and the sound power and aperture open area at each point. A set of approximately twenty points is taken to resolve the noise signature.

A target isobel noise level is determined (block 403). In certain embodiments, the target isobel noise level is the ideal fan noise level to meet the electronic system acoustic requirements. In other embodiments, the target isobel level may also be the maximum acceptable fan noise level to meet the electronic system acoustic requirements.

The difference between the actual measured acoustic sound power and the target isobel is calculated (block 406) and is described further below. A speed ratio is calculated (block 408) and is described further below. A volumetric flow rate at the target isobel point is calculated from the measured volumetric flow rate and the calculated speed ratio (block 410) and is described further below. A static pressure at the target isobel point is calculated from the original measured static pressure and the calculated speed ratio (block 412) and is described further below.

The difference between the actual measured acoustic sound power and the target noise isobel is calculated (block 406) is determined by equation (1).

ΔL=Lₘₑₐₛ−L_{isobel}_{_{—}}_{tgt} (1)

A speed ratio is calculated (block 408) and is determined by equation (2).

N_{R}=10^{ΔL/5} (2)

The speed necessary to operate at the target noise isobel level is calculated from the measured speed and the calculated speed ratio (block 409). The speed at the target isobel point (block 409) is determined by equation (3).

Nᵢₛₒ_{_{—}}_{tgt}=N_{R}·N_{measured} (3)

A volumetric flow rate at the target isobel point is calculated from the measured volumetric flow rate and the calculated speed ratio (block 410). The volumetric flow rate at the target isobel point (block 410) is determined by equation (4).

Qᵢₛₒ_{_{—}}_{tgt}=N_{R}·Q_{measured} (4)

A static pressure at the target isobel point is calculated from the original measured static pressure and the calculated speed ratio (block 412). The static pressure at the target isobel point (block 412) is determined by equation (5).

Pᵢₛₒ_{_{—}}_{tgt}=N_{R}²·P_{measured} (5)

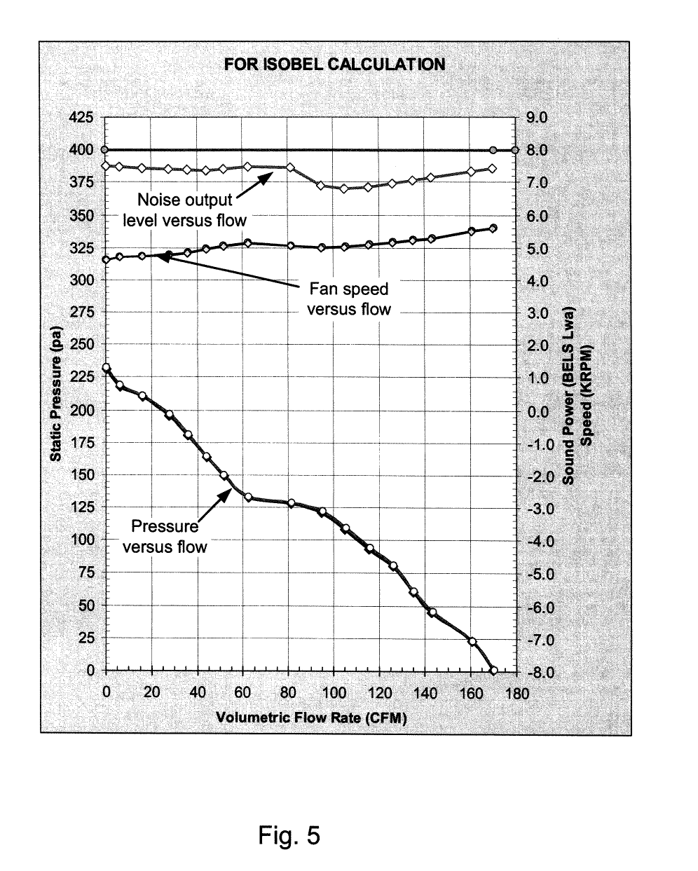

FIG. 5 illustrates an example of the measured device data arranged in graphical form displaying the relationship between static pressure, volumetric flow rate, and sound power. In the example shown in FIG. 5, the measurements were obtained from a fan operating at a constant motor voltage input. The relationship of the measured volumetric flow rate of the fan versus the measured static pressure is shown by the lowest curve. The middle curve shows how the measured speed of the fan motor changed under various torque loads produced by changing the hydraulic load. In other words, the middle curve shows the relationship between the measured speeds of the fan versus the measured volumetric flow rates of the fan. The upper curve shows how the noise output level of the fan changed along a single operating characteristic. In other words, the upper curve shows the relationship between the measured noise output of the fan versus the measured volumetric flow rate of the fan. Typically, the noise output level of a fan may change by 5 to 7 dB, due to the combined speed variation and aerodynamic loading acoustic effects.

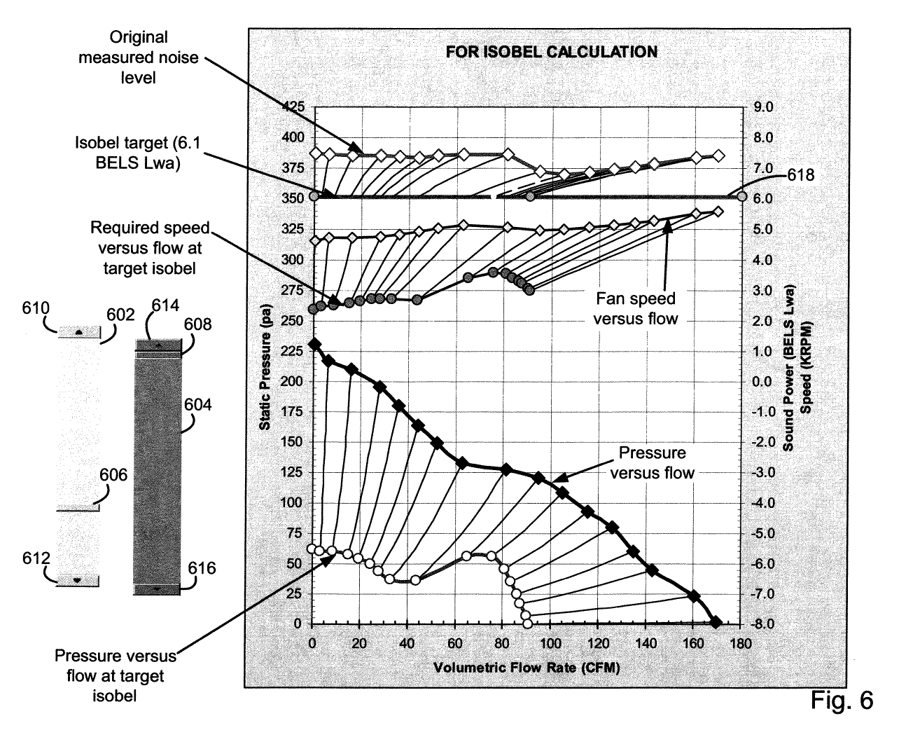

FIG. 6 illustrates an example where a target isobel noise level is determined to be 6.1 BELS Lwa. The fan operating parameters in the hydraulic plane that would achieve the target Isobel noise level are determined by methodology 400, and also illustrated in FIG. 6. To depict the determined target isobel noise level, a line 618 is drawn, for example at the target isobel noise level of 6.1 BELS Lwa. The isobel coordinates at this noise level in the hydraulic plane are desired and determined by methodology 400. In other words, it is desired to determine the operating parameters of the device that results in the device having a noise output of 6.1 BELS Lwa. In the example shown in FIG. 6, the target isobel noise level falls below all of the measured noise values.

Methodology 400 is applied to the measured data to generate a calculated speed curve (the middle curve depicted in FIG. 6). In other words, when methodology 400 is applied, the relationship of the fan's calculated speed versus the fan's calculated volumetric flow rate is determined. This calculated speed versus calculated volumetric flow rate relationship is utilized to determine the rotational speed of the fan motor that that causes the fan to operate at the target noise isobel of 6.1 BELS Lwa.

Methodology 400 is also applied to the measured data to generate a calculated relationship between static pressure and volumetric flow rate. This curve, for example, is the lowest curve seen on FIG. 6. In other words, when methodology 400 is applied the relationship of the fan's calculated pressure versus the calculated volumetric flow rate is utilized to predict the resulting volumetric flow rate and resulting pressure for the fan operating at calculated speed that resulting in the fan to operate at the target noise isobel of 6.1 BELS Lwa.

FIG. 6 also depicts a target sound power level user interface 602 and hydraulic plane adjustment user interface 604. Sound power level user interface 602 includes a target sound power level increase interface 610, a target sound power level decrease interface 612, and a current target sound power level interface 606. Target sound power level increase interface 610 allows a user to increase the current target sound power level interface to the target sound power level if desired. Target sound power level decrease interface 612 allows a user to decrease the current target sound power level interface to the target sound power level if desired. A user may adjust the current target sound power level interface 606 to match the target sound power level, or otherwise allow for the user to indicate the target sound power level. When the user adjusts the current sound power level interface 606, target power level 618 may also correspondingly adjust.

Hydraulic plane adjustment user interface 604 includes a hydraulic plane adjustment increase interface 614, a hydraulic plane adjustment decrease interface 616, and a current hydraulic plane adjustment interface 608. Hydraulic plane adjustment user interface 604 allows a user to graphically morph or otherwise graphically adjust the measured fan speed versus volumetric flow rate to the calculated fan speed versus volumetric flow rate at the target isobel level. Hydraulic plane adjustment user interface 604 may allow a user to graphically morph or otherwise graphically adjust the measured static pressure versus volumetric flow rate to the calculated static pressure versus volumetric flow rate at the target isobel level.

Hydraulic plane adjustment increase interface 614 allows a user to increase the graphical adjustment of the measured fan speed versus volumetric flow rate to the calculated fan speed versus volumetric flow rate at the target isobel level, and/or the static pressure versus volumetric flow rate to the calculated static pressure versus volumetric flow rate at the target isobel level.

Hydraulic plane adjustment decrease interface 616 allows a user to decrease the graphical adjustment of the measured fan speed versus volumetric flow rate to the calculated fan speed versus volumetric flow rate at the target isobel level, and/or the static pressure versus volumetric flow rate to the calculated static pressure versus volumetric flow rate at the target isobel level.

After the graphic morphing or otherwise graphic adjustment of the fan speed versus volumetric flow rate and the graphic adjustment of the static pressure versus volumetric flow rate, the calculated fan speed versus volumetric flow rate plot at the target isobel level and the calculated static pressure versus volumetric flow rate plot at the target isobel level are displayed.

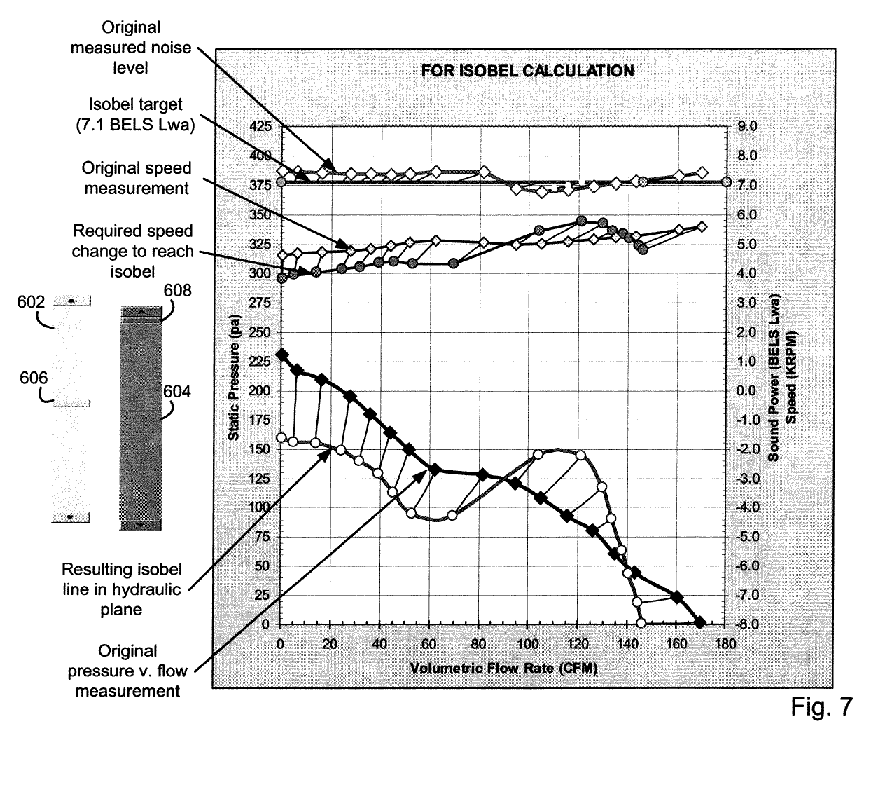

FIG. 7 illustrates an example where the target isobel noise level is 7.1 BELS Lwa. The fan operating parameters in the hydraulic plane to achieve the target Isobel noise level are also illustrated. The example illustrated in FIG. 7 is based upon the same measurements as the example illustrated in FIG. 6. However, as depicted in FIG. 7, the target isobel of 7.1 BELS falls in between the maximum and minimum measured noise levels. Where the target noise level falls below the measured noise curve, the motor speed should be reduced. When the target noise falls above the measured value, the motor speed should be increased. Methodology 400 inherently produces these necessary speed value directions. Therefore, these equations also automatically produce the proper speed value directions in the case where all the measured noise points fall below the target noise level.

In the plots shown in FIG. 6 and FIG. 7, thin connecting spider lines are drawn connecting original measured points to the resulting applicable calculated points. The use of spider lines may help illustrate the graphic morphing or graphic adjustment between the measured points and the calculated points.

### Applications of the Model

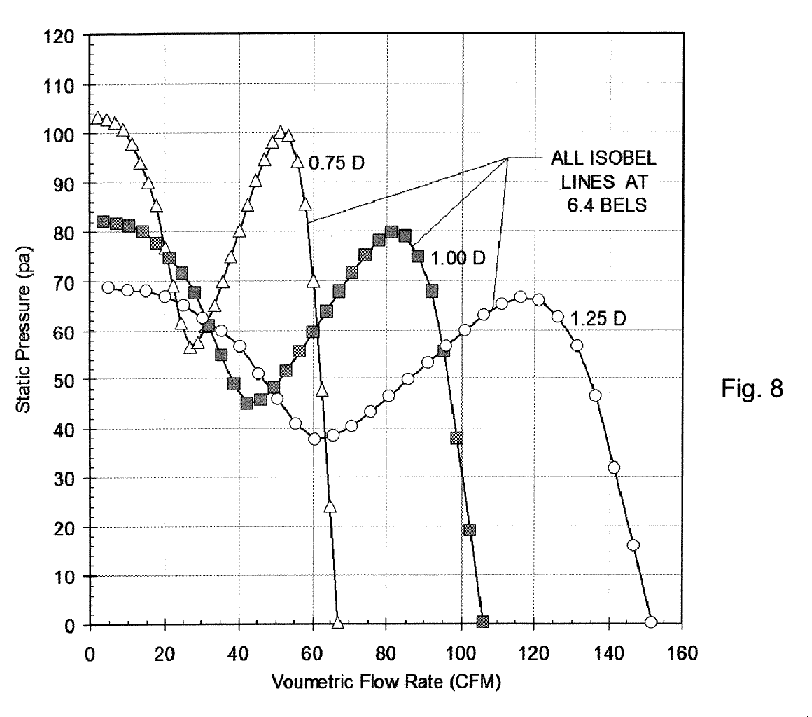

FIG. 8 depicts an embodiment of the present invention where methodology 400 is utilized to determine the noise surfaces of similar fan types each having different diameters. In an embodiment, the diameters of the fans with the noise surface outputs as shown in FIG. 8 is scaled to 75% and 125% of the original (1.00 D) utilizing fan law equations 6-9 shown below. In the present embodiment, data accumulation process (block 404) may occur for one fan and the different diameter fan parameters is extrapolated. In another embodiment, methodology 400 may utilized to determine the noise surfaces of each of the multiple diameter fans.

The diameters of the fans is scaled for example to 75% and 125% of the original (1.00 D) utilizing the equations below:

flow coefficient φ= [symbol] ND³ (6)

pressure coefficient ψ=P/ρ*N²D² (7)

Where [symbol] is a volumetric flow rate, N is a rotational speed, and D is the blade diameter. In utilizing these equations in an embodiment of the present invention, air is treated as incompressible. For sound power L_{W} (decibels) and specific sound power level L_{Ws}, at the point of rating previous work provides these acoustic relationships:

L_{W}=L_{Ws}+10 log Q+20 log Pₛ (8)

L_{W}=L_{Ws}+50 log N+70 log D (9)

FIG. 8 depicts isobel lines indicating the flow and pressure that each of these fan sizes would attain at the same sound power output of 6.4 BELS.

Noise surface extension to multiple fans:

Multiple fans in combination: Multiple fan systems are utilized to provide cooling redundancy. The strategy for projecting the acoustic performance of multiple fans is to determine the point of rating at which each fan will operate, then account the effect of multiple fans. Reductions in flow and pressure delivery due to non-ideal system effects may also be taken into account by applying degradation factors to the ideal models. For example, a particular system of fans may have the same number of fans in parallel at each series stage. Let np be the number of fans in parallel in each stage, and let there be ns stages of fans placed in series. The total number of fans in the system is then: nfans=ns*np.

The total noise output of the system is determined by taking the logarithmic sum of the individual fans each operating at the same point of rating, with the implicit assumption that no noise interaction exists between the two fan outputs.

L_{WA(sys)}=L_{WA(fan)}+log(ns*np) (bels) (9)

Thus, a two fans system results in a noise level that is 0.3 bels or 3 decibels higher than a single fan, four fans are 0.6 bels higher, and so on.

Fans in parallel and series: Fans in an ideal parallel arrangement output a net volumetric flow rate that is the linear sum of unit level flows at the same static pressure as a singular fan: [symbol] =np* [symbol] Fans in an ideal series arrangement output linearly additive static pressures at the same volumetric flow rate as a singular fan: P_{sys}=np*P_{fan}.

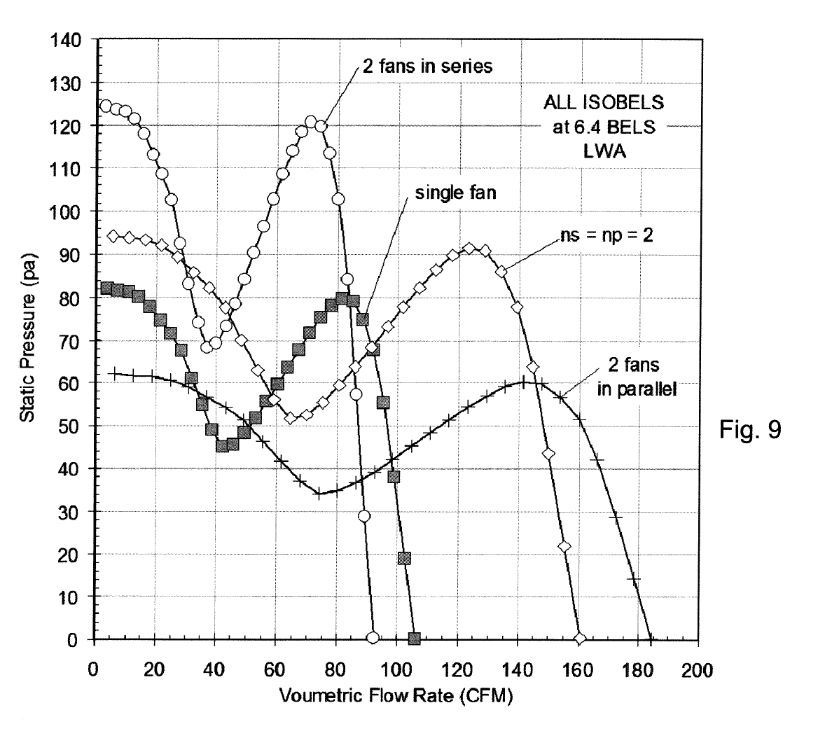

FIG. 9 shows four various possible fan arrangements, each arrangement resulting in a noise level of, for example, 6.4 BELS Lwa. A user may consider the hydraulic requirements desired for a particular electronic product. The four possible arrangements shown in FIG. 9 are: a single fan, two fans in series, two fans in parallel, and four fans arranged in two series stages each series having two fans in parallel. If, for example, the hydraulic requirements for the particular electronic product are 90 CFM and 70 pascals, the single fan at higher speed would match the noise output of the system of 4 slower fans arranged in two series stages of 2 fans in parallel each. If, for example, the hydraulic requirements for the particular electronic product are 120 CFM, 90 pa, the four fans arranged in two series stages each series having two fans in parallel offers the quietest noise level. In another comparison of the various possible fan arrangements shown in FIG. 9, it is seen that at the hydraulic requirement of 70 CFM, two fans in series offers a higher pressure capacity (120 pa) than single or parallel fan combinations which offer a lower pressure capacity (only 70 pa and 34 pa, respectively) at the same noise level of 6.4 BELS.

In another embodiment, various fan options or arrangements are compared by surface subtraction. Various things concerning various devices or device arrangements are learned from side-by-side comparison of noise contour plots. This comparison allows, for example, determining whether the lowest noise for a given hydraulic requirement is achieved by: changing the speed of a single fan, changing to a larger fan, changing to multiple fans in series or in parallel, changing to a quieter model of the same size fan, or changing to an entirely different device type.

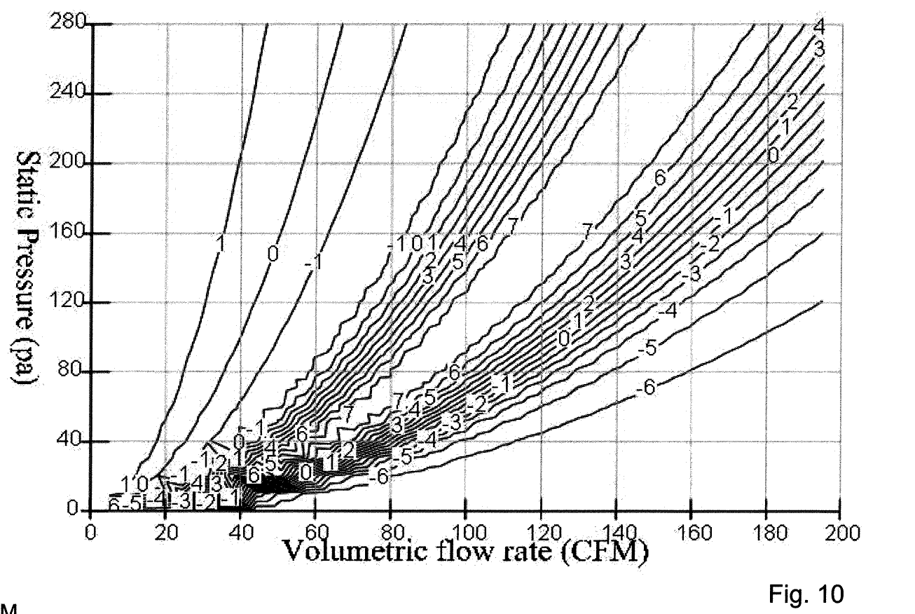

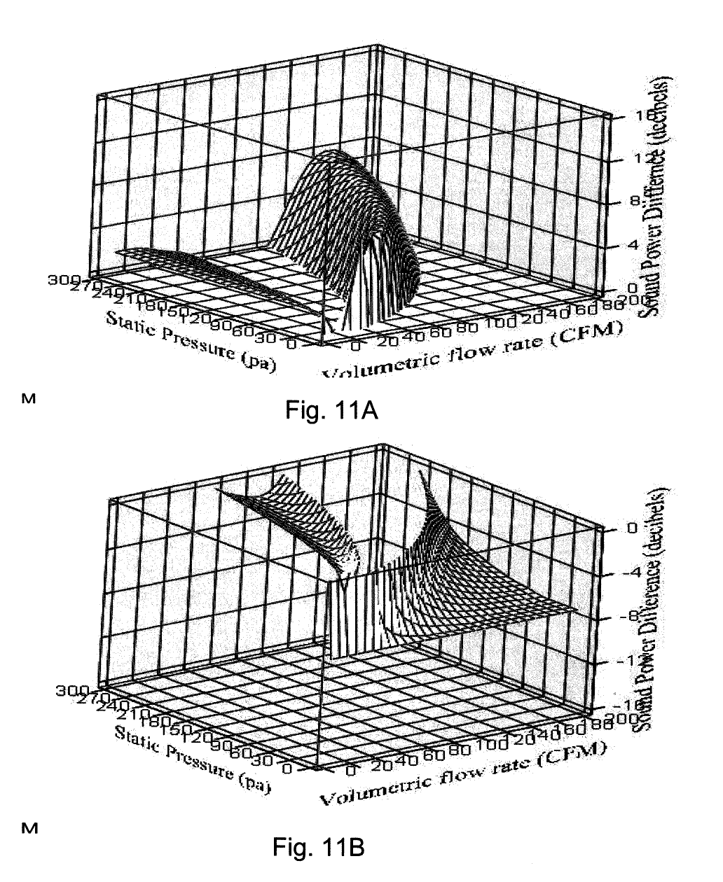

FIG. 10 illustrates an example of noise difference contours LWA₁−LWA₂ for a 150 mm fan 1 compared to a 120 mm fan 2. In order to show how a pair of fan arrangements differs in noise output in a quantified manner, the LWA values at the same flow-pressure points are subtracted to produce a noise-difference map over the hydraulic plane. FIG. 10 shows an example of this noise-difference in contour form, and FIG. 11A and FIG. 11B shows an example of this noise-difference in surface profile form. These example maps show that a 25% larger homologous fan 1 is up to 7-8 dB noisier in a specified higher pressure region, and 6 dB quieter in a lower pressure region. In other words, the side-by-side explicit Isobel mappings is utilized to determine which fan configuration within an electronic system will deliver the most flow and pressure at a given noise level constraint, and the noise difference maps is utilized to determine which fan configuration will produce the lowest noise level at a given hydraulic operating target.

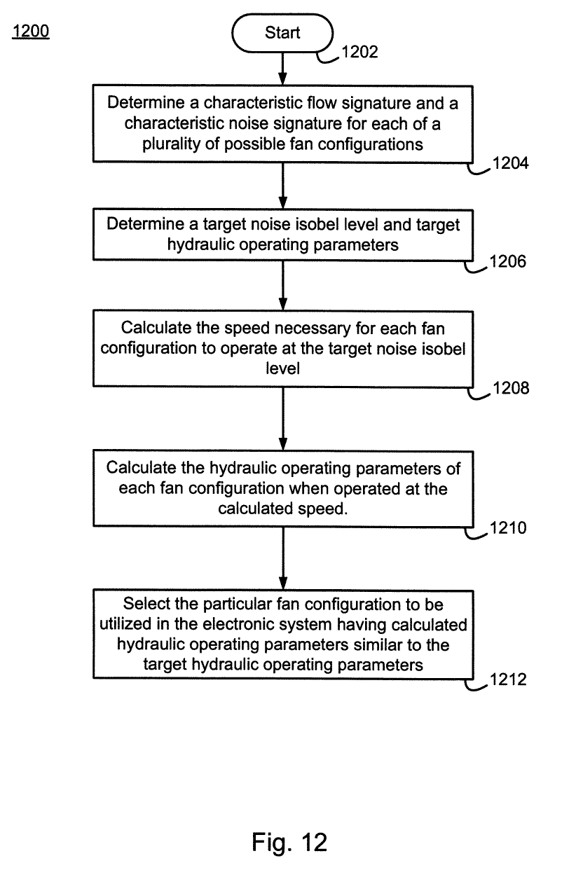

FIG. 12 illustrates a method 1200 for selecting a fan configuration from a plurality of possible fan configurations to be utilized in an electronic system, according to an embodiment of the present invention. In an embodiment, a fan configuration is a single fan, and method 1200 is utilized to compare the single fan to a second single fan type in order to select a particular fan to be utilized to cool an electronic application. In another embodiment, a fan configuration is a single fan, and method 1200 is utilized to compare the single fan to multiple fan configurations in order to select a particular fan configuration to be utilized to cool an electronic application. In another embodiment, a fan configuration is a multiple fan configuration, and method 1200 is utilized to compare the multiple fan configuration to a different multiple fan configuration in order to select a particular fan configuration to be utilized to cool an electronic application. In other words, method 1200 is utilized to compare a first fan configuration (single fan or multiple fan) to a different of multiple fan configuration (single fan or multiple fan) in order to select a particular fan configuration to be utilized to cool an electronic application.

Method 1200 beings at block 1202. A characteristic flow signature is determined for each of the plurality of fan configurations (block 1204). A characteristic noise signature for each of the plurality of possible fan configurations are also determined (block 1204). A target noise isobel level is determined (block 1206). Target hydraulic operating parameters are also determined (block 1206). The speed necessary for each fan configuration to operate at the target noise isobel level is calculated (block 1208). The hydraulic operating parameters of each fan configuration when operated at the calculated speed are calculated (bock 1210). The particular fan configuration to be utilized in the electronic system is selected (block 1212). In an embodiment, the selected fan configuration has calculated hydraulic operating parameters similar to the target hydraulic operating parameters (block 1212).

In another embodiment, determining a characteristic flow signature and a characteristic noise signature for each of the plurality of possible fan configurations further includes measuring at least the volumetric flow rate, static pressure, impeller rotation speed, and isobel noise level for each of the plurality of possible fan configurations. The characteristic flow signature and the characteristic noise signature is determined by measuring the volumetric flow rate, static pressure, and sound power level of a single unit level fan. This data is manipulated to create data associated with alternative fan configurations as described above. In other words, the data from a single fan may be utilized to understand the hydraulic and sound relationship if that fan would be utilized in multiple fan configurations.

In another embodiment, calculating the speed necessary for each fan configuration to operate at the target noise isobel level further includes calculating the difference between the measured isobel noise level and the target isobel noise level; determining a speed ratio; and multiplying the measured impeller rotation speed by the speed ratio to determine the speed necessary for each fan configuration to operate at the target noise isobel level.

In another embodiment, the speed ratio (N_{R}) is determined by the following expression: N_{R}=10^{ΔL/5} where ΔL=Lₘₑₐₛ−L_{isobel}_{_{—}}_{tgt}, where Lₘₑₐₛ is the measured isobel noise level, and where L_{isobel}_{_{—}}_{tgt} is the target isobel noise level.

In another embodiment, calculating the hydraulic operating parameters of each fan configuration when operated at the calculated speed further includes calculating a volumetric flow rate at the target isobel point and calculating a static pressure at the target isobel point.

In another embodiment, the volumetric flow rate at the target isobel point (Qᵢₛₒ_{_{—}}_{tgt}) is determined by the following expression: Qᵢₛₒ_{_{—}}_{tgt}=N_{R}·Q_{measured}, where Q_{measured} is the measured volumetric flow rate.

In another embodiment, the static pressure at the target isobel point (Pᵢₛₒ_{_{—}}_{tgt}) is determined by the following expression: Pᵢₛₒ_{_{—}}_{tgt}=N_{R}²·P_{measured}, where P_{measured} is the measured static pressure.

In another embodiment, selecting the particular fan configuration to be utilized in the electronic system having calculated hydraulic operating parameters similar to the target hydraulic operating parameters further includes determining which fan configuration results in the lowest noise at the hydraulic operating target.

In another embodiment, selecting the particular fan configuration to be utilized in the electronic system having calculated hydraulic operating parameters similar to the target hydraulic operating parameters, further includes determining which fan configuration results in the greatest volumetric flow rate and pressure delivery at the target isobel noise level.

By utilizing these mapping procedures over a sufficient range of fan types, sizes, and combinations, it is possible to assemble an overall picture of the minimum noise levels required to reach specific hydraulic operating targets. Such a map reveals the minimum acoustic consequences of achieving hydraulic design points. The volumetric consumption of each fan option is over-plotted to show the acoustic benefit of allowing more space in a system design.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature.

It is to be understood that the present invention, in accordance with at least one present embodiment, includes or results in elements or components that is selected for use in, installed in, or utilized in at least one electronic enclosure, such as general-purpose server having at least one heat generating component, and being capable of running suitable software programs.

Although illustrative embodiments of the present invention have been described herein with reference to the accompanying drawings, it is to be understood that the invention is not limited to those precise embodiments, and that various other changes and modifications is affected therein by one skilled in the art without departing from the scope or spirit of the invention.

The invention claimed is:

1. A method for selecting a fan configuration from a plurality of possible fan configurations to be utilized in an electronic system, the method comprising:
determining a characteristic flow signature and a characteristic noise signature for each of the plurality of possible fan configurations;
determining a target noise isobel level of the electronic system and target hydraulic operating parameters of the electronic system;
calculating the speed necessary for each fan configuration to operate at the target noise isobel level;
calculating the hydraulic operating parameters of each fan configuration when operated at the calculated speed; and
selecting the particular fan configuration to be utilized in the electronic system having calculated hydraulic operating parameters similar to the target hydraulic operating parameters.

2. The method of claim 1, wherein determining a characteristic flow signature and a characteristic noise signature for each of the plurality of possible fan configurations, further comprises:
measuring at least the volumetric flow rate, static pressure, impeller rotation speed, and isobel noise level for each of the plurality of possible fan configurations.

3. The method of claim 2, wherein calculating the speed necessary for each fan configuration to operate at the target noise isobel level, further comprises:
calculating the difference between the measured isobel noise level and the target isobel noise level;
determining a speed ratio; and
multiplying the measured impeller rotation speed by the speed ratio to determine the speed necessary for each fan configuration to operate at the target noise isobel level.

4. The method of claim 3, wherein the speed ratio (N_{R}) is determined by the following expression: N_{R}=10^{ΔL/5} where ΔL=Lₘₑₐₛ−L_{isobel}_{_{—}}_{tgt}, where Lₘₑₐₛ is the measured isobel noise level, and where L_{isobel}_{_{—}}_{tgt} is the target isobel noise level.

5. The method of claim 4, wherein calculating the hydraulic operating parameters of each fan configuration when operated at the calculated speed further comprises:
calculating a volumetric flow rate at the target isobel point; and
calculating a static pressure at the target isobel point.

6. The method of claim 5, wherein the volumetric flow rate at the target isobel point (Qᵢₛₒ_{_{—}}_{tgt}) is determined by the following expression: Qᵢₛₒ_{_{—}}_{tgt}=N_{R}·Q_{measured}, where Q_{measured} is the measured volumetric flow rate.

7. The method of claim 6, wherein the static pressure at the target isobel point (Pᵢₛₒ_{_{—}}_{tgt}) is determined by the following expression: Pᵢₛₒ_{_{—}}_{tgt}=N_{R}²·P_{measured}, where P_{measured} is the measured static pressure.

8. The method of claim 7, wherein selecting the particular fan configuration to be utilized in the electronic system having calculated hydraulic operating parameters similar to the target hydraulic operating parameters, further comprises:
determining which fan configuration results in the lowest noise at the hydraulic operating target.

9. The method of claim 8, wherein selecting the particular fan configuration to be utilized in the electronic system having calculated hydraulic operating parameters similar to the target hydraulic operating parameters, further comprises:
determining which fan configuration results in the greatest volumetric flow rate and pressure delivery at the target isobel noise level.

10. The method of claim 9, wherein a fan configuration is a single fan, multiple fans in parallel, multiple fans in series, or multiple fans in parallel and series.

11. An electronic system comprising a selected fan configuration selected from a plurality of possible fan configurations, the selected fan configuration selected by a method comprising:
determining a characteristic flow signature and a characteristic noise signature for each of the plurality of possible fan configurations;
determining a target noise isobel level and target hydraulic operating parameters;
calculating the speed necessary for each fan configuration to operate at the target noise isobel level;
calculating the hydraulic operating parameters of each fan configuration when operated at the calculated speed; and
selecting the particular fan configuration to be utilized in the electronic system having calculated hydraulic operating parameters similar to the target hydraulic operating parameters.

12. The electronic system claim 11, wherein determining a characteristic flow signature and a characteristic noise signature for each of the plurality of possible fan configurations, further comprises:
measuring at least the volumetric flow rate, static pressure, impeller rotation speed, and isobel noise level for each of the plurality of possible fan configurations.

13. The electronic system of claim 12, wherein calculating the speed necessary for each fan configuration to operate at the target noise isobel level, further comprises:
calculating the difference between the measured isobel noise level and the target isobel noise level;
determining a speed ratio; and
multiplying the measured impeller rotation speed by the speed ratio to determine the speed necessary for each fan configuration to operate at the target noise isobel level.

14. The electronic system of claim 13, wherein the speed ratio (N_{R}) is determined by the following expression: N_{R}=10^{ΔL/5} where ΔL=Lₘₑₐₛ−L_{isobel}_{_{—}}_{tgt}, where Lₘₑₐₛ is the measured isobel noise level, and where L_{isobel}_{_{—}}_{tgt} is the target isobel noise level.

15. The electronic system of claim 14, wherein calculating the hydraulic operating parameters of each fan configuration when operated at the calculated speed further comprises:
calculating a volumetric flow rate at the target isobel point; and
calculating a static pressure at the target isobel point.

16. The electronic system of claim 15, wherein the volumetric flow rate at the target isobel point (Qᵢₛₒ_{_{—}}_{tgt}) is determined by the following expression:
Qᵢₛₒ_{_{—}}_{tgt}=N_{R}·Q_{measured}, where Q_{measured} is the measured volumetric flow rate.

17. The electronic system of claim 16, wherein the static pressure at the target isobel point (Pᵢₛₒ_{_{—}}_{tgt}) is determined by the following expression:
Pᵢₛₒ_{_{—}}_{tgt}=N_{R}²·P_{measured}, where P_{measured} is the measured static pressure.

18. The electronic system of claim 17, wherein selecting the particular fan configuration to be utilized in the electronic system having calculated hydraulic operating parameters similar to the target hydraulic operating parameters, further comprises:
determining which fan configuration results in the lowest noise at the hydraulic operating target.

19. The electronic system of claim 18, wherein selecting the particular fan configuration to be utilized in the electronic system having calculated hydraulic operating parameters similar to the target hydraulic operating parameters, further comprises:
determining which fan configuration results in the greatest volumetric flow rate and pressure delivery at the target isobel noise level.

20. The electronic system of claim 19, wherein a fan configuration is a single fan, multiple fans in parallel, multiple fans in series, or multiple fans in parallel and series.
